(19) United States
(12) Patent Application Publication
(10) Pub. No.: US 2007/0130810 A1
(43) Pub. Date: Jun. 14, 2007

(54) Card carrying digital media

(76) Inventor: David Bradford Howe, Los Angeles, CA (US)

Correspondence Address: MARC E. HANKIN, ESQ., 11414 THURSTON CIRCLE, LOS ANGELES, CA, 90049, US

(21) Appl. No.: 11/301,692

(22) Filed: Dec. 12, 2005

(51) Int. Cl. G09F 1/00

(52) U.S. Cl. 40/124.06

(57) ABSTRACT

The present invention is directed to an apparatus that can be used to send messages with electronic data media, and comprises an unfolded base layer with a front and a back side, at least one message area, and at least one electronic data media attached to the base layer.

### FIELD OF INVENTION

This invention relates generally to a message card, and more particularly a card that enables a person to send a message with detachable electronic media.

### BACKGROUND

Historically, picture post cards have been used for displaying the scenery of tourist resorts or the like. These conventionally comprise a single flat card that includes a front side having an image, and a back side having space where the sender can provide postal information, and an area where the sender can write a personal greeting or message. More recently, greeting cards and post cards have been designed to incorporate media disks. One-piece promotional mailers are also well known in the art. These mailers are typically sent through the postal service system with a bulk rate postage. The mailers usually have advertisements, informational messages, and other promotional verbiage imprinted upon them.

U.S. Pat. No. 6,499,654 is directed to a postcard for carrying compact disks, and comprises a filler card and transparent plastic layer that surrounds the card, filler card, and compact disk. However, the procedures involved with mail processing are demanding and likely to tear the plastic layer, thereby releasing the contents therein.

U.S. Pat. No. 6,640,473 is directed to a greeting card with a first panel, a second panel, and a video disk attached to the first panel. Although this approach allows messages to be conveyed with a video disk, it is less practicable for use for promotional mailings because of the folded, two panel format.

Examples of promotional mailers are disclosed in U.S. Pat. Nos. 4,957,311 and 5,076,490. These earlier art mailers, however, are formed from a single sheet of material such that the structural integrity of the mailers is in question. Moreover, such mailers only convey conventional written messages and cannot be used to send messages with electronic media.

In light of the foregoing, there is a need to provide a mailing device that permits individuals to send messages with electronic media to others in a way that is simple, cost effective, attractive, and secure.

### SUMMARY OF THE INVENTION

This invention is directed towards overcoming the above shortcomings by disclosing an apparatus that can be used cost effectively and easily to convey information to others using electronic data media such as a compact disk or digital video disk.

In one embodiment, the apparatus in accord with the invention comprises a single panel, unfolded base layer with a front and a back side, at least one message area on the base layer, and at least one electronic data media attached to the base layer.

In another embodiment, the base layer comprises a single layer of material; alternatively it can comprise a plurality of layers.

In a further construction, electronic data media is attached to the front side of the base layer. In yet another construction, the data media is attached between the plurality of layers.

In another aspect of the invention, at least one layer of the plurality of layers comprises a transparent material to allow the data media to be viewed.

The foregoing, and other features and advantages of the invention, will be apparent from the following, more particular description of the preferred embodiments of the invention, the accompanying drawings, and the claims.

### BRIEF DESCRIPTION OF THE DRAWINGS

FIG. 1 is a perspective view of a first embodiment of the invention

FIG. 2 is a perspective front view of the envelope belonging to the first embodiment.

FIG. 3 is a perspective front view of the second embodiment of the invention.

FIG. 4 shows a perspective side view of three embodiments of the invention.

FIG. 5 shows a perspective front view of the second embodiment of the invention with a pocket.

### DETAILED DESCRIPTION OF THE DRAWINGS

In the following detailed description of various embodiments of the invention, numerous specific details are set forth in order to provide a thorough understanding of various aspects of one or more embodiments of the invention, however, one or more embodiments of the invention may be practiced without these specific details. In other instances, well-known methods, procedures, and/or components have not been described in detail so as not to unnecessarily obscure aspects of the embodiments of the invention.

The invention as disclosed can be used to convey messages with electronic data media to others, and comprises an unfolded base layer and at least one data media attached to the base layer, or contained within the multiple layers of the base layer.

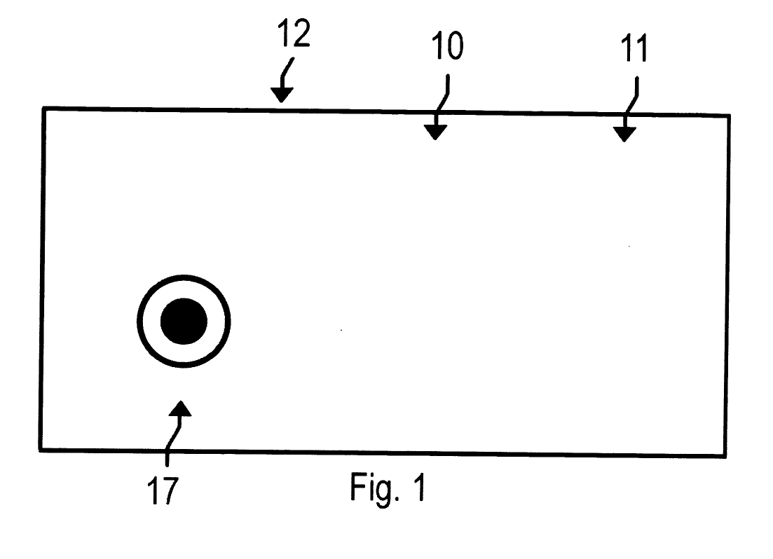

Turning now to the figures in which one presently preferred embodiment of the invention appears, FIG. 1 shows a perspective view of a single panel, unfolded base layer 10, which is made of two sides, a front 11 and a back side 12. Messages can be printed onto either the front side 11, the back side 12, or both sides of the base layer. Messages may be suitable for a particular holiday, event, or situation, or alternatively, the message contains information regarding a product, service, merchant, brand, restaurant, etc. It is understood that these messages are printed onto the base layer using conventional methods that permit printing of ink or dyes onto cards, whether using printing devices or performed by hand. Alternatively, messages can first be written/typed onto paper which can then be affixed onto either side of the base layer. It is also understood that graphics, designs, and images (all of which together are now described herein as ‘artwork’). Such artwork can be printed onto either side of the base layer in combination with text, and make the card more appealing for the recipient.

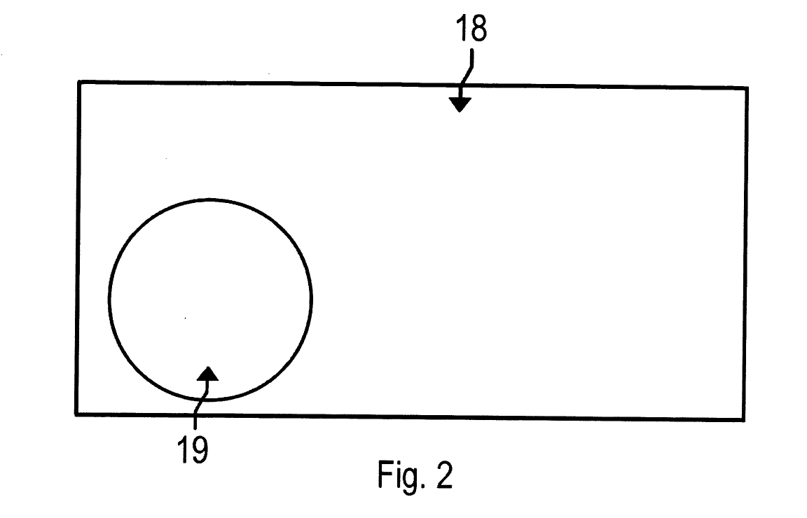

FIG. 1, shows one embodiment of the invention where at least one electronic data media is attached via a hub like device 17 to the front side 11 of the base layer. The media can also be affixed to the base layer using other conventional methods known in the art to fix paper, photographs, and cards to a display backing, such as, but not limited to, adhesives, tape, or hook and eye fasteners. The entire single panel, unfolded base layer, with data media affixed, is then enclosed inside an appropriately sized conventional envelope. FIG. 2 shows the envelope 18 with a transparent circular window 19 configured to be in the exact position of the enclosed and affixed media disk(s), thereby allowing the receiver to perceive the gift.

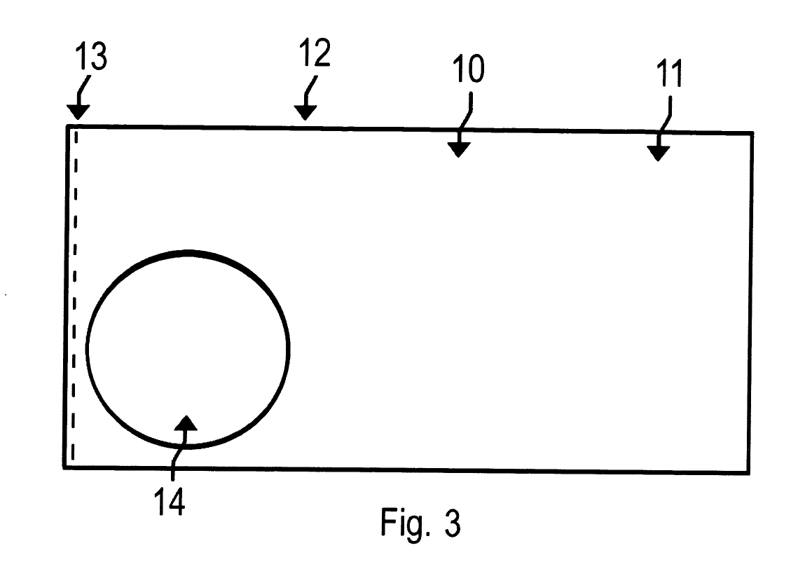

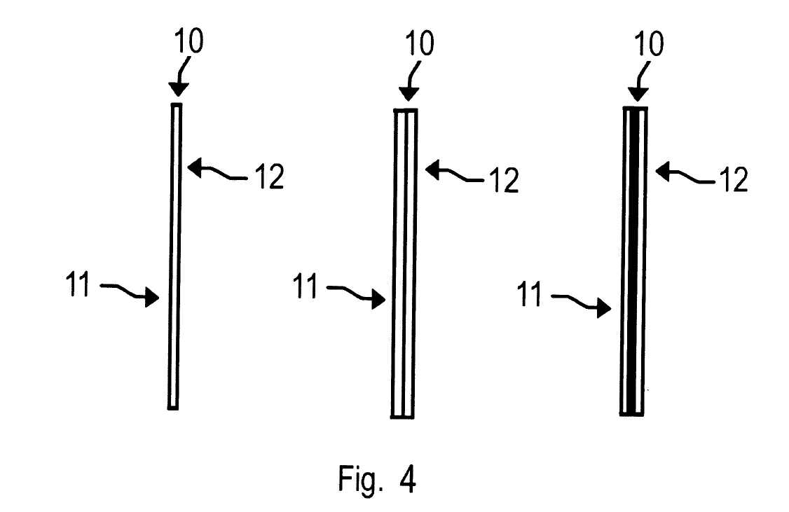

FIG. 3 shows a second embodiment of the invention. FIG. 4 shows that this second embodiment has a single panel, unfolded base layer 10 which comprises one, two, or a plurality of layers.

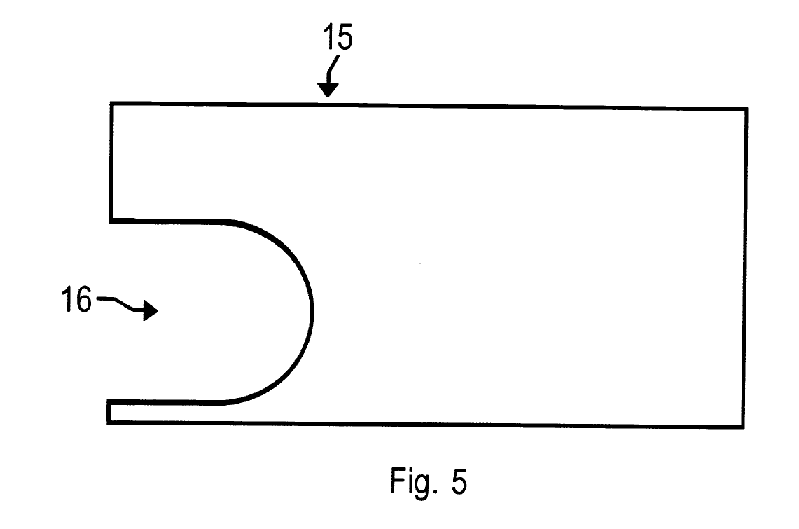

FIG. 5 shows inner layer(s) 15 cut and assembled in such a way as to form a single layer. When a plurality of layers are used, the central layer has a pocket or cut-out 16 to hold the media disk(s). It is understood that this pocket can be facing up or down, and located either on the right or left side of the base layer. The media disk(s) can be released from the pocket by the user tearing or cutting open the base layer(s) along a marked cutting line 13 (see FIG. 3). It should be appreciated that the cutting line can be located on any side of the card.

The layers (or layer) can be made of material such as, but not limited to, paper, recycled paper, cardboard, plastic, cloth, fabric, leather, cellophane, or composite material. It is also understood, that the unit can comprise different proportions of the aforementioned materials either within a single layer or between successive layers. As is known in the art, the selection of material influences the selection of adhesive used to bind the material, and vice versa, but any adhesive providing suitable bonding strength, peel test characteristics, and the like is suitable. The preferred adhesives are cold extrusion adhesives, but hot-melt adhesives are also acceptable. In this embodiment, the layer representing either the back or front side of the base layer when assembled, should be made of material that allows the user to be able to write or print mailing information.

Postal addresses can be printed or affixed onto either the front or back side of the base layer depending upon user preference. Sufficient space should be left by the user when printing any postal address to leave sufficient space for affixing postage.

At least one electronic data media 14 disk is inserted within the pocket 16. This pocket secures the media and prevents it from being dislodged during shipping. The ability to hold the media without a complicated and/or costly hub or similar feature is an important advantage of the invention. Further, in this embodiment there is no need for an envelope but rather the entire assembly can be shipped as is.

Although not limited to such, the overall size of this embodiment when used as a promotional mailer is preferably limited to a first class post card, wherein the peripheral edges define a quadrilateral having a length of between 5.0″ and 6.0″, and a width of between 3.5″ and 4.25″. However, the promotional mailer may be of varying sizes with added postage paid to send to the prospective user. The thickness of the layers when assembled to form the promotional mailer is preferably between 0.007″ and 0.016″ so as to meet the requirements of a first class post card. However, the promotional mailer can be thicker with additional postage paid, if desired by the sender.

In a third embodiment, at least one of the plurality of layers is made of transparent material, thereby allowing the enclosed electronic data media disk(s) to be viewed in transit and immediately upon receipt.

The electronic media can be a DVD, CD, HD-DVD, memory card, or other devices used to store data, images, video, speech and music; or a combination thereof. It should also be recognized that various dimensions of the base layer and media are possible. For instance, base layers that fit inside conventional 4^{1/8}×9^{1/2} inch envelopes can be used to mail mini media disks; alternatively, it is possible to use larger size base layers so that full size media disks, rather than mini-media disks, can be mailed with size 9×12 inch envelopes. The message content on the disks may contain words (printed or spoken), music or images, or a combination of the three, appropriate for a greeting card to acknowledge a particular holiday, situation or occasion, i.e., birthday, Christmas, Hanukah, thank you, congratulations, graduation, wedding, new baby, etc. Alternatively, the message content may include commercial or advertising content for promoting a product or service.

It should be understood that the invention has application far beyond the exemplary embodiments presented and described herein, and as such is not to be limited to those embodiments. In addition, the invention is not limited to the particularly physical configuration, but instead is adaptable. All changes, modifications, variations, and other uses and applications which do not depart from the spirit and scope of the invention are deemed to be covered by the invention.

1. A messaging article comprising:
a single panel, unfolded base layer with a front and a back side, wherein said base layer comprises a single layer,
at least one message area on said base layer,
and at least one electronic data media attached to said base layer.

2. The messaging article of claim 1, wherein the media is selected from a group consisting of DVD disk, CD disk, HD-DVD, and memory card.

3. The messaging article of claim 2, wherein the message is selected from a group consisting of greetings and promotional information.

4. The messaging article of claim 3, wherein said unfolded base layer is a material selected from a group consisting of paper, recycled paper, cardboard, plastic, cloth, fabric, leather, cellophane, and composite material.

5. The messaging article of claim 4, wherein the media is attached to the back side of said base layer.

6. The messaging article of claim 5, wherein the media is attached to front side of said base layer.

7. The messaging article of claim 5, wherein the article is placed inside an envelope with a circular window, where said window is located at a position to reveal said media.

8. The messaging article of claim 6, wherein the article is placed inside an envelope with a circular window, where said window is located at a position to reveal said media.

9. A messaging article comprising:
a single panel, unfolded base layer with a front and a back side, wherein said base layer comprises a single layer,
at least one message area on said base layer,
and at least one electronic data media attached to said base layer,
wherein the media is selected from a group consisting of DVD disk, CD disk, HD-DVD, and memory card,
wherein the message is selected from a group consisting of greetings and promotional information,
wherein said unfolded base layer is a material selected from a group consisting of paper, recycled paper, cardboard, plastic, cloth, fabric, leather, cellophane, and composite material,
wherein the media is attached to the back side of said base layer,
wherein the article is placed inside an envelope with a circular window, where said window is located at a position to reveal said media.

10. A messaging article comprising:
a single panel, unfolded base layer with a front and a back side,
wherein said base layer comprises a plurality of layers fabricated to form a single unit,
at least one message area on said base layer,
and at least one electronic data media attached to said base layer.

11. The messaging article of claim 10, wherein the media is selected from a group consisting of DVD disk, CD disk, HD-DVD, and memory card.

12. The messaging article of claim 11, wherein the message is selected from a group consisting of greetings and promotional information.

13. The messaging article of claim 12, wherein said plurality of layers is a material selected from a group consisting of paper, recycled paper, cardboard, plastic, cloth, fabric, leather, cellophane, and composite material.

14. The messaging article of claim 13, wherein the media is attached between said plurality of layers.

15. The messaging article of claim 14, wherein said plurality of layers comprises at least one transparent material to allow the data media to be viewed.

16. A messaging article comprising:
a single panel, unfolded base layer with a front and a back side,
wherein said base layer comprises a plurality of layers fabricated to form a single unit,
at least one message area on said base layer,
and at least one electronic data media attached to said base layer,
wherein the media is selected from a group consisting of DVD disk, CD disk, HD-DVD, and memory card,
wherein the message is selected from a group consisting of greetings and promotional information.
wherein said plurality of layers is a material selected from a group consisting of paper, recycled paper, cardboard, plastic, cloth, fabric, leather, cellophane, and composite material,
wherein the media is attached between said plurality of layers, and
wherein said plurality of layers comprises at least one transparent material to allow the data media to be viewed.
